(19) United States
(12) Patent Application Publication
(10) Pub. No.: US 2004/0208250 A1
(43) Pub. Date: Oct. 21, 2004

(54) Method and switching arrangement for the identification of pupin coils

(76) Inventor: Heinrich Schenk, Munchen (DE)

Correspondence Address: JENKINS & WILSON, PA, 3100 TOWER BLVD, SUITE 1400, DURHAM, NC, 27707, US

(21) Appl. No.: 10/766,338

(22) Filed: Jan. 28, 2004

Related U.S. Application Data
(63) Continuation of application No. PCT/EP03/05333, filed on May 21, 2003.

(30) Foreign Application Priority Data
Jun. 13, 2002 (DE) 10226348.5

(51) Int. Cl. H04B 3/00

(52) U.S. Cl. 375/257

(57) ABSTRACT

The invention relates to a method and a switching arrangement for the identification of Pupin coils in a telecommunications line.

In order to identify Pupin coils, periodic transmission symbols are transmitted by a transmission device (2, 4, 5), an analog reception signal is received, sampled and processed further by a reception device (3, 6), the frequency response of the reception signal is determined for a prescribed number of frequency points in a prescribed frequency range, a function with function values (F(fᵢ)) is calculated from the real part and the imaginary part of the frequency response of the reception signal, and a differential vector (Δrᵢ) is determined from the function values (F(fᵢ)) by a computing unit (11, 12, 13, 14, 15), a criterion which specifies whether a pupinized line is present being derived from the components of the differential vector (Δrᵢ).

The invention relates to a method and a switching arrangement for the identification of Pupin coils in a telecommunications line in accordance with the preamble of Claims 1 and 9, respectively.

In order to increase the range when making telephone calls, earlier it has been the case that occasionally inductances (so-called Pupin coils or load coils) have been connected into the subscriber connection line at regular distances. Within the telephone bandwidth up to about 3.5 kHz, said inductances effect a lower attenuation and thus an increase in the range or an improvement in the transmission quality when making telephone calls.

For the frequency range above about 3.5 kHz, the attenuation rises greatly, however, so that such connection lines are not suitable for a DSL connection technology (e.g. ISDN, SDSL, ADSL, VDSL). Only if it is ensured that a connection line is free of Pupin coils can said line be converted to a DSL transmission technology.

A decision as to whether a line contains a Pupin coil may be made either by evaluation of installation documents that are possibly present or by corresponding measurements. In the case of measurements, a distinction is made between single-ended and two-ended measuring arrangements. In the case of two-ended measuring arrangements, the presence of Pupin coils can be deduced very precisely by measurement of the frequency-dependent line attenuation. However, such measuring arrangements are not particularly well suited to practical use since both the line end on the switching side and the line end on the subscriber side have to be connected to the measuring arrangement.

In the case of a single-ended measuring arrangement, the presence of a Pupin coil can be identified by measurement of the input resistance within the telephone bandwidth up to about 4 kHz. A magnitude of the input resistance that falls monotonically with the frequency is obtained in the case of a line not connected with Pupin coils. It amounts to less than 1500 Ω at 3.5 kHz. Depending on the line length and the line parameters, the input resistance may also amount to only about 400 Ω. In the case of being connected up with Pupin coils, a profile with a plurality of local maxima results for the input resistance in the frequency range below 4 kHz, the number of local maxima depending on the number of Pupin coils. The absolute maximum is at about 3 to 4 kHz and amounts to more than 3000 Ω. By measuring the input resistance in the frequency range between 3 and 4 kHz, it is thus possible to ascertain whether Pupin coils are present. The input resistance has to be measured directly at the line input. However, the line is connected up to a DSL transceiver always via a transformer and a hybrid arrangement (two-wire—four-wire conversion). The transformer alters the frequency-dependent profile of the input resistance, i.e. of the transformer line, in such a way that a Pupin coil that is possibly present can no longer be identified simply and reliably in this simple manner.

It is an object of the invention to specify a method and also a corresponding circuit arrangement for the identification of Pupin coils.

This object is achieved according to the invention by means of the method according to Claim 1 and the circuit arrangement for the identification of Pupin coils according to Claim 9. The subclaims relate to preferred embodiments of the invention.

The method according to the invention is based on using not the input resistance but the echo transfer function for the identification of the Pupin coils (load coils).

The method according to the invention for the identification of Pupin coil [sic] interposed in a subscriber connection line accordingly comprises the following steps: transmission of periodic transmission symbols by a transmission device, reception, sampling and further processing of an analog reception signal by a reception device, determination of the frequency response of the reception signal for a prescribed number of frequency points in a prescribed frequency range, calculation of a function with function values from the real part and the imaginary part of the frequency response of the reception signal, and determination of a differential vector from the function values by a computing unit, a criterion which specifies whether a pupinized line is present being derived from the components of the differential vector.

In a preferred embodiment of the method, a first partial vector and a second partial vector are formed from the function values by a function generator, an intermediate vector is determined from the second partial vector by a matrix multiplication device and the differential vector is formed from the first partial vector and the intermediate vector in a differential stage. Preferably, in this case, the first partial vector comprises, as components, the function values with an even-numbered index and the second partial vector comprises, as components, the function values with an odd-numbered index.

Preferably, the criterion consists in the difference between a maximum value and a minimum value of the components of the differential vector being compared with a differential prescribed value in a comparator device, and a signal being output if the difference is greater than the differential prescribed value, or in the sum of the absolute values of the components of the differential vector being compared with a sum prescribed value in a comparator device, and a signal being output if the sum is greater than the sum prescribed value, or in the sum of the squares of the components of the differential vector being compared with a square sum prescribed value in a comparator device, and a signal being output if the sum is greater than the square sum prescribed value, or in the number of components of the differential vector which are significantly different from zero being compared with a zero component prescribed value in a comparator device, and a signal being output if the sum is greater than the zero component prescribed value.

In order, in the last case, to be able to determine the number of components of the differential vector which are significantly different from zero, the coefficients are rounded and represented with a finite word length, the quantization size (word length) being chosen such that the values zero result for all the coefficients in the case of a non-pupinized line.

The preferred prescribed frequency range lies between about 1 and 5 kHz.

The device for the method for the identification of Pupin coil [sic] interposed in a subscriber connection line is provided with a transmission device for the transmission of periodic transmission symbols, a reception device for the reception, sampling and further processing of an analog reception signal, and a computing unit for determining the frequency response of the reception signal for a prescribed number of frequency points in a prescribed frequency range, calculating a function with function values from the real part and the imaginary part of the frequency response of the reception signal, and determining a differential vector from the function values, a criterion which specifies whether a pupinized line is present being derived from the components of the differential vector.

One advantage of the invention consists, inter alia, in the fact that the measurement of the echo transfer function requires the processing of exclusively the reception signal which is sampled in the DSL receiver when special test signals are transmitted. The method is therefore suitable particularly in the case of being connected up to a DSL transformer and a corresponding hybrid arrangement and can be integrated in a DSL transceiver.

Further features and advantages of the invention emerge from the following description of exemplary embodiments, in which reference is made to the accompanying drawings.

FIG. 1 shows the block diagram of a transceiver known per se.

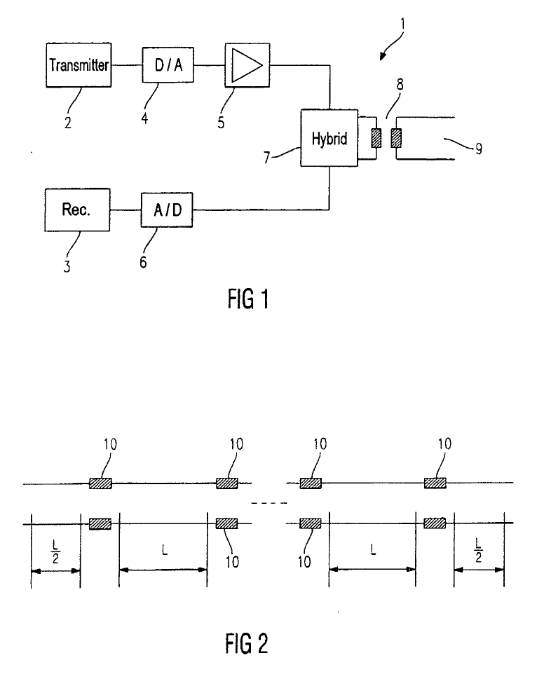

FIG. 2 shows the line configuration of a pupinized line.

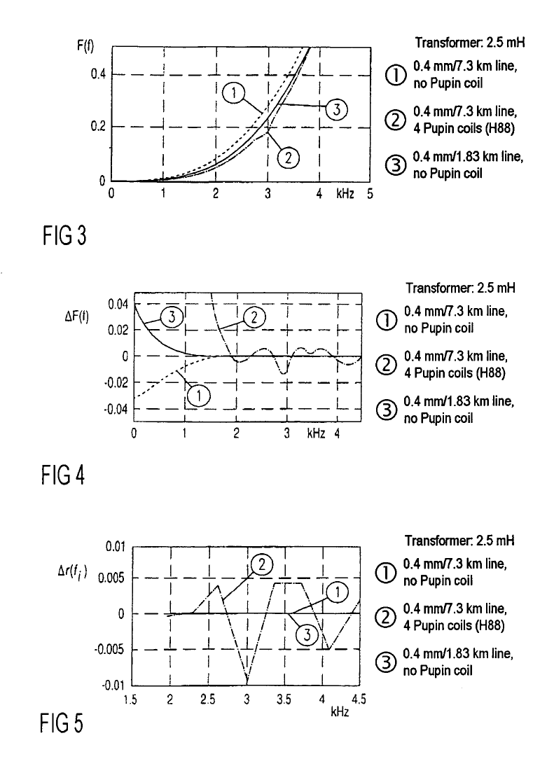

FIG. 3 shows a profile of F(f) for different line configurations.

FIG. 4 shows a profile of ΔF(f) for different line configurations

FIG. 5 shows the profile of the frequency response of Δr(fᵢ) for different line configurations.

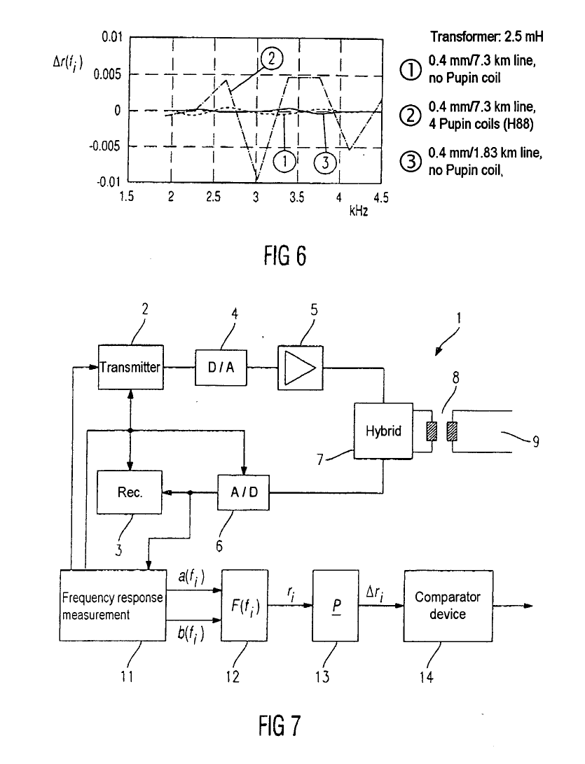

FIG. 6 shows the profile of the real and imaginary parts of the frequency response of Δr(fᵢ) for different line configurations.

FIG. 7 shows a first embodiment of the circuit arrangement according to the invention for the identification of Pupin coils.

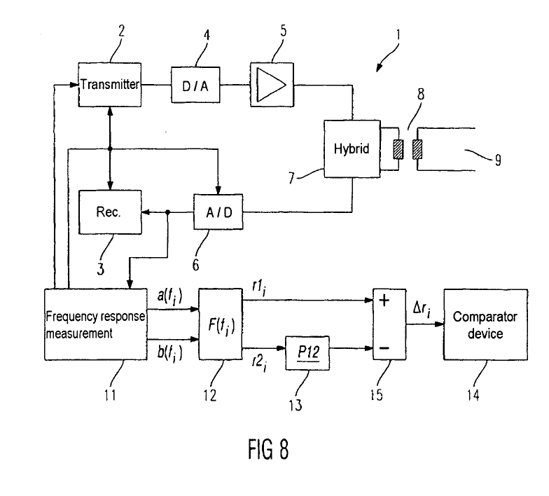

FIG. 8 shows a second embodiment of the circuit arrangement according to the invention for the identification of Pupin coils.

FIG. 1 shows the block diagram of a digital transceiver 1 known per se, having a digital transmitter 2, a digital receiver 3, a D/A converter 4 at the transmitter end and an A/D converter 6 at the receiver end, a line amplifier (line driver) 5 and also a line connection (hybrid) 7. A transmission line 9 is connected to the line connection 7 via a line transformer 8.

The subscriber connection line 9 is either a non-pupinized line (without Pupin coils) or a pupinized line (with Pupin coils).

A simple nomenclature is used in the USA for the description of the Pupin line. Lines bearing the designation D66 and H88 are found the most often. The inductance of the Pupin coil is 66 mH in the case of the D66 line, and 88 mH in the case of the H88 line. The distance between two coils is 1356 m and 1829 m (4450 ft and 6000 ft) , respectively. In this case, the D66 line has a limiting frequency of about 3.4 kHz and the H88 line has a limiting frequency of about 4 kHz.

The line configuration of a pupinized line is shown in FIG. 2. The illustration shows a connection line 9 with inductances 10, in which case the line 9 may be a D66 line or an H88 line, i.e. the length L between two adjacent inductances 10 is 1356 m in the case of the D66 line and 1829 m in the case of the H88 line.

In order to identify whether the connected transmission line contains Pupin coils, the transfer function is evaluated for different frequencies. In this case, the term transfer function denotes the ratio of reception signal to transmission signal when a sinusoidal signal having a specific frequency is transmitted.

The determination of the transfer function is explained below.

The intention is to determine the transfer function at the frequency fₒ. For this purpose, a baud rate f_{T} of

f_{T}=N·f₀,

where N is even (e.g. N=32), is chosen for the transceiver.

A periodic data sequence with

$$\frac{N}{2}$$

positive and

$$\frac{N}{2}$$

negative symbols each having the same amplitude is then transmitted. Consequently, the transmission signal also contains odd-numbered harmonics in addition to the fundamental with the frequency f₀.

In order to determine the transfer function at the frequency fₒ, the fundamental has to be filtered out of the reception signal. For this purpose, the signal sampled at the baud rate (symbol rate) f_{T} is multiplied on the one hand by the cosine of the fundamental and on the other hand by the sine of the fundamental. The following two signals are then obtained:

$$\begin{matrix}{y}_{1} ( k ) = y ( k ) \cdot cos ( 2 \cdot π \cdot \frac{k}{N} ) \\ and \\ {y}_{2} ( k ) = y ( k ) \cdot sin ( 2 \cdot π \cdot \frac{k}{N} )\end{matrix}$$

where k=1 to N.

The real part and the imaginary part of the transfer function are obtained from the arithmetic mean of the two signal sequences, it being necessary to effect averaging over an integer number M of signal periods.

The real part and the imaginary part of the frequency response can thus be determined using the following relationships:

$$\begin{matrix}Re \{ H ( {f}_{0} ) \} = \frac{2}{N \cdot M} {\sum }_{k = 1}^{N \cdot M} {y}_{1} ( k ) \\ and \\ Im \{ H ( {f}_{0} ) \} = \frac{2}{N \cdot M} {\sum }_{k = 1}^{N \cdot M} {y}_{2} ( k ) .\end{matrix}$$

In order to measure the frequency response, it is necessary to determine the real part and the imaginary part for different further frequencies f in addition to f₀ by corresponding alteration of the baud rate (symbol rate) f_{T}.

For the detection of Pupin coils, both the real part and the imaginary part

a(f)=Re{H(f)}

and

b(f)=Im{H(f)}

of the frequency response are processed further.

Firstly, a suitable function for the further processing is formed from a and b. This function may be e.g. the square of the magnitude F(f)=a(f)²+b(f)² formed from real and imaginary parts, the magnitude F(f)=\sqrt{a(f)²+b(f)²} formed from real and imaginary parts, the sum F(f)=a(f)+b(f) from real and imaginary parts, the difference F(f)=a(f)−b(f) formed from real and imaginary parts or the product F(f)=a(f)·b(f) formed from real and imaginary parts.

In the case of a line without Pupin coils, a largely smooth profile which is frequency-dependent is obtained for the function F derived from a and b, while a line with Pupin coils results in a slightly “wavy” profile in the frequency range of about 2 kHz to 4 kHz.

The profile of F is illustrated in FIG. 3. In FIG. 3, the square of the magnitude of the frequency response F(f)=a(f)²+b(f)² was used as the function for the further processing.

Three different curve [sic], designated by “1”, “2” and “3”, are plotted in FIG. 3. Curve “1” corresponds to a line having a thickness of 0.4 mm and a length of 7.3 km. It does not have a Pupin coil in the example shown. Curve “2” corresponds to a line having a thickness of 0.4 mm and a length of 7.3 km. It has four Pupin coils in the H88 arrangement in the example shown. Curve “3” corresponds to a line having a thickness of 0.4 mm and a length of 1.83 km. It does not have a Pupin coil in the example shown.

Only support points of the function used at some frequency points in the range of about 1 kHz to about 5 kHz are selected for the further processing. A corresponding reference function F(f) is calculated from these support values. The reference function represents a power function of the frequency and approximates the originally measured function in the sense of the least square deviation:

$$F ( f ) = {\sum }_{i = 0}^{n} {α}_{i} \cdot {f}^{i} .$$

The coefficients αᵢ are calculated from the support values of the function F(f) which are measured at the frequency values f.

While the reference function F(f) corresponds to the derived function very well in the case of a line without a Pupin coil, an approximation with a power function is possible only with large deviations in the case of a line with Pupin coils.

The difference between the original function and the reference function is now used to identify Pupin coils.

FIG. 4 shows the respective differential function of the examples used in FIG. 3 for the profile. The parameters of the curves “1”, “2” and “3” are the same as in FIG. 3. The coefficients αᵢ were calculated from in each case eight support values in the range of 1.9 to 4.5 Hz.

The method for calculating the αᵢ and the determination of the reference function therefrom are described in more detail below.

m frequency points fᵢ where i=1 to m are considered. These are used to form the rectangular matrix Q with the coefficients

Q_{i,j}=fᵢ^{j=1}

where i=1 to m and j=1 to n+1. The following rectangular matrix then results e.g. for n=4 and m=8:

$$Q = [ \begin{matrix}1 & {f}_{1} & {f}_{1}^{2} & {f}_{1}^{3} & {f}_{1}^{4} \\ 1 & {f}_{2} & {f}_{2}^{2} & {f}_{2}^{3} & {f}_{2}^{4} \\ 1 & {f}_{3} & {f}_{3}^{2} & {f}_{3}^{3} & {f}_{3}^{4} \\ 1 & {f}_{4} & {f}_{4}^{2} & {f}_{4}^{3} & {f}_{4}^{4} \\ 1 & {f}_{5} & {f}_{5}^{2} & {f}_{5}^{3} & {f}_{5}^{4} \\ 1 & {f}_{6} & {f}_{6}^{2} & {f}_{6}^{3} & {f}_{6}^{4} \\ 1 & {f}_{7} & {f}_{7}^{2} & {f}_{7}^{3} & {f}_{7}^{4} \\ 1 & {f}_{8} & {f}_{8}^{2} & {f}_{8}^{3} & {f}_{8}^{4}\end{matrix} ] .$$

A vector r with the components

rᵢ=F(fᵢ)

is formed from m values of the function F(f) to be evaluated.

An explanation is given below of two alternatives in the evaluation of the vector r in order to determine a differential vector for the further evaluation of the measurement.

In the case of a first evaluation method, for m=8, the vector r can be represented as follows:

$$r = [ \begin{matrix}F ( {f}_{1} ) \\ F ( {f}_{2} ) \\ F ( {f}_{3} ) \\ F ( {f}_{4} ) \\ F ( {f}_{5} ) \\ F ( {f}_{6} ) \\ F ( {f}_{7} ) \\ F ( {f}_{8} )\end{matrix} ] .$$

The vector r is used to obtain a coefficient vector α with the coefficients αᵢ according to the relationship

α=(Q^{T}·Q)⁻¹·Q^{T}·r.

In this case, the superscript T denotes the transposition operation.

With

R=(Q^{T}·Q)⁻¹·Q^{T}

this can be summarized as:

α=R·r.

The rectangular matrix R is dependent only on the frequency support values and the vector r is dependent only on the support values of the function F(fᵢ) to be evaluated.

The differential function is likewise evaluated only using the support values with which the coefficient vector was calculated.

With the coefficient vector α, the following is obtained for the reference vector

r_{ref}=Q·α,

and the following results for the differential vector

Δr=r−r_{ref}=r−Q·α=r−Q·R·r=[E−Q·R]·r,

where the matrix E is an (m×m) unit matrix.

If the following is written for the matrix

P=[E−Q−R],

the differential vector can be represented as

Δr=P·r.

In this case, P is a square, symmetrical (m×m) matrix which depends only on the frequency support points. The vector r directly contains the support values of the function which is to be evaluated and is obtained by corresponding combination from the measured real and imaginary parts of the transfer function. Accordingly, each value of the differential vector is obtained by multiplying a row vector by a column vector.

An alternative approach is specified below, which permits a more rapid calculation in order to determine the differential vector.

In the case of this second approach, the original vector r is divided into two partial vectors r1 and r2, in which case, by way of example, the vector r1 contains the components of r with the odd frequency numbers and the vector r2 contains the components of r with the even frequency numbers.

The vector r2 can be used to calculate the unknown coefficients of the vector a according to

α=(Q₂^{T}·Q₂)⁻¹·Q₂^{T}·r2=R2·r2,

where the matrices Q₂ and R2 in each case result from the same frequency support values as r2 (e.g. the even frequency support values).

The reference vector is only calculated for the frequency support values which correspond to the vector r1. The following is obtained for said reference vector

r1_{ref}=Q₁·α=Q₁·R2·r2.

In this case, the matrix Q₁ results from the frequency support values which were taken as a basis for determining the vector r1.

The differential vector is then

Δr1=r1−r1_{ref}=r1−Q₁·R2·r2.

With

P12=Q₁·R2

the following is obtained therefrom

Δr1=r1−P12·r2.

The differential vector Δr1 thus results from the difference between the vector r1 and a vector which results from the product of a square matrix P12 and the vector r2. In this case, in the above example, r1 is determined from the odd frequency support values and r2 is determined from the even frequency support values.

The realization outlay is lower in the case of the second embodiment than in the case of the first embodiment for determining the differential vector, since the matrix multiplication is carried out with a lower number of coefficients.

The differential vectors are shown in FIG. 5. The parameters of curves “1”, “2” and “3” are the same as in FIG. 3 and FIG. 4, respectively.

The values correspond to the differential functions from FIG. 4 if, for the frequencies, use is made of the support values thereof. For calculation purposes, the support values of the transfer function values determined from the frequency response values were taken as a basis with the accuracy of the computer. Since the frequency response values are determined by measurement, a finite accuracy must inevitably be expected for a(f) and b(f). The differential vectors determined with a finite accuracy of the real part a(f) and of the imaginary part b(f) of 10 bits are illustrated in FIG. 6. The parameters of curves “1”, “2” and “3” are the same as in FIG. 3, FIG. 4 and FIG. 5, respectively. Although the values of the differential vector increase for the non-pupinized lines, they are still significantly less than for the pupinized line. The presence of Pupin coils can thus be deduced by suitable evaluation of the differential vector.

An explanation is given below of the possibilities for evaluating the differential function or the differential vector in order to arrive at a criterion for the decision as to whether a Pupin coil is present in the line examined—independently of its configuration as a D66 or H88 line.

As can be gathered from FIGS. 5 and 6, non-pupinized lines result in differential vectors whose components are smaller than in the case of pupinized lines. The differential vector can therefore be used to identify Pupin coils. It is necessary firstly to derive a criterion, it being possible for the actual identification to be effected by comparing said criterion with a threshold value that is to be chosen in a suitable manner.

Possible criteria are 1) the difference between the maximum value and the minimum value of the components of the differential vector, i.e. criterion=Δrₘₐₓ−Δrₘᵢₙ, 2) the sum of the absolute values of the components of the differential vector, i.e.

$$criterion = {\sum }_{i} Δ \vert {r}_{i} \vert ,$$

or 3) the sum of the squares of the components of the differential vector, i.e.

$$criterion = {\sum }_{i} Δ {r}_{i}^{2} .$$

4) the number of components which are different from zero may be defined as a further criterion. For this purpose, the coefficients are firstly rounded and represented with a finite word length. The quantization size (word length) is chosen such that the values zero result for all the coefficients in the case of a non-pupinized line. In the above example, the word length chosen may be 9 bits, for example, and the quantization level is thus 2⁻⁸.

The criteria 1) to 4) mentioned as an example do not have to be checked directly after the determination of the differential vector; the differential vector may still be modified beforehand in order that the checking of one of the criteria 1) to 4) is simplified, for example. One possible modification consists e.g. in forming the difference between two adjacent vector components:

dΔrᵢ=Δrᵢ−Δrᵢ₋₁

or in forming the difference in the difference between two adjacent vector components:

ddΔrᵢ=dΔrᵢ−dΔrᵢ₋₁.

The method for the identification of Pupin coils may be implemented using the circuit arrangement illustrated in FIG. 7. This resorts to the first method for calculating the differential vector. Elements identical to those in FIG. 1 have the same reference symbols as there. The construction of FIG. 7 differs from that in FIG. 1 by the fact that a frequency response measuring device 11 periodically outputs transmission symbols to the transmitter 2, which are transmitted by the transmitter 2 on the subscriber connection line 9. At the same time, the frequency response measuring device 11 outputs the symbol clock to the transmitter 2, the receiver 3 and the A/D converter 6 connected upstream of the latter.

The received analog echo signal is tapped off between the AD converter 6 and the receiver 3 and sampled in the frequency response measuring device 11 in order to generate the components a(f) and b(f) (more precisely the support values a(fᵢ) and b(fᵢ)) for a specific number of frequency points in the range of about 1 to 5 kHz. The components a(f) and b(f) are the real part and the imaginary part, respectively, of a function F(fᵢ) which is calculated in a function generator 12.

The function generator 12 outputs the output values rᵢ to a matrix multiplication device 13, which determines a differential vector from said values with the aid of a matrix multiplication. For this purpose, as described above, the output values rᵢ are multiplied by a matrix P=[E−Q·R], thereby producing the values Δrᵢ, which are input variables of a comparator device 14.

In the comparator device 14, a suitable criterion derived from the coefficients of the differential vector is used to make a reliable statement as to whether or not a pupinized line is present.

A second embodiment of the circuit arrangement according to the invention for the identification of Pupin coils is shown in FIG. 8. In this embodiment, the differential vector is calculated according to the alternative, second method. Elements identical to those in FIGS. 1 and 7 have the same reference symbols as there. The construction of FIG. 8 differs from that in FIG. 7 by the fact that the output values r1ᵢ and r2ᵢ are formed by the function generator 12. In this case, by way of example, the components with an even-numbered index form a first partial vector r1 and the components with an odd-numbered index form a second partial vector r2. The partial vector r1 with the components r1ᵢ is output directly to a differential stage 15, while the partial vector r2 with the components r2ᵢ forms the input variable of the matrix multiplication device 13, which determines an intermediate vector P12·r2 from the values r2ᵢ with the aid of a matrix multiplication. Said intermediate vector is subtracted from the partial vector r1 in the differential stage 15, thereby producing the differential vector with the components Δrᵢ, which are input variables of the comparator device 14.

The method is then brought to an end analogously to the device in FIG. 7.

The measuring method can be integrated in a simple manner in a DSL transceiver. The subsystems such as transmitter and A/D converter which are required for the measurement of the frequency response are present anyway, so that they do not incur any additional outlay. The signal processing required for the evaluation can be carried out with the aid of a processor which is quite generally likewise present, it being necessary merely to extend the firmware of the transceiver for this purpose.

List of Reference Symbols

1 transceiver

2 transmitter

3 receiver

4 D/A converter

5 line amplifier, line driver

6 A/D converter

7 line connection, hybrid stage

8 line transformer

9 connection line of subscriber

10 inductance in connection line

11 frequency response measurement

12 function generator

13 matrix multiplication device

14 comparator device

15 differential stage

In the claims:

1. Method for the identification of Pupin coil interposed in a subscriber connection line, having the following steps:
(a) transmission of periodic transmission symbols by a transmission device,
(b) reception, sampling and further processing of an analog reception signal by a reception device,
(c) determination of the frequency response of the reception signal for a prescribed number of frequency points in a prescribed frequency range,
(d) calculation of a function with function values (F(fᵢ)) from the real part and the imaginary part of the frequency response of the reception signal, and
(e) determination of a differential vector (Δrᵢ) from the function values (F(fᵢ)) by a computing unit,
a criterion which specifies whether a pupinized line is present being derived from the components of the differential vector (Δrᵢ).

2. Method according to claim 1, wherein a first partial vector (r1) and a second partial vector (r2) are formed from the function values (F(fᵢ)) by a function generator, an intermediate vector (P12·r2) is determined from the second partial vector (r2) by a matrix multiplication device and the differential vector (Δrᵢ) is formed from the first partial vector (r1) and the intermediate vector (P12·r2) in a differential stage.

3. Method according to claim 2, wherein the first partial vector (r1) comprises, as components, the function values (F(fᵢ)) with an even-numbered index and the second partial vector (r2) comprises, as components, the function values (F(fᵢ)) with an odd-numbered index.

4. Method according to claim 1, wherein the criterion consists in the difference between a maximum value and a minimum value of the components of the differential vector (criterion=Δrₘₐₓ−Δrₘᵢₙ) being compared with a differential prescribed value in a comparator device, and a signal being output if the difference is greater than the differential prescribed value.

5. Method according to claim 1, wherein the criterion consists in the sum of the absolute values of the components of the differential vector
$$criterion = {\sum }_{i} Δ \vert {r}_{i} \vert ,$$
being compared with a sum prescribed value in a comparator device, and a signal being output if the sum is greater than the sum prescribed value.

6. Method according to claim 1, wherein the criterion consists in the sum of the squares of the components of the differential vector
$$( criterion = {\sum }_{i} Δ {r}_{i}^{2} )$$
being compared with a square sum prescribed value in a comparator device, and a signal being output if the sum is greater than the square sum prescribed value.

7. Method according to claim 1, wherein the criterion consists in the number of components of the differential vector (Δrᵢ) which are significantly different from zero being compared with a zero component prescribed value in a comparator device, and a signal being output if the sum is greater than the zero component prescribed value.

8. Method according to claim 7, wherein, in order to determine the number of components of the differential vector (Δrᵢ) which are significantly different from zero, the coefficients are rounded and represented with a finite word length, the quantization size (word length) being chosen such that the values zero result for all the coefficients in the case of a non-pupinized line.

9. Method according to claim 1, wherein the prescribed frequency range lies between about 1 and 5 kHz.

10. Device for the identification of Pupin coil interposed in a subscriber connection line, having:
(a) a transmission device for the transmission of periodic transmission symbols,
(b) a reception device for the reception, sampling and further processing of an analog reception signal, and
(c) a computing unit for:
(i) determining the frequency response of the reception signal for a prescribed number of frequency points in a prescribed frequency range,
(ii) calculating a function with function values (F(fᵢ)) from the real part and the imaginary part of the frequency response of the reception signal, and
(iii) determining a differential vector (Δrᵢ) from the function values (F(fᵢ)),
a criterion which specifies whether a pupinized line is present being derived from the components of the differential vector (Δrᵢ).

11. Device according to claim 10, wherein the computing unit comprises a function generator for forming a first partial vector (r1) and a second partial vector (r2) from the function values (F(fᵢ)), a matrix multiplication device for determining an intermediate vector (P12·r2) from the second partial vector (r2) and a differential stage for forming the differential vector (Δrᵢ) from the first partial vector (r1) and the intermediate vector (P12·r2).

12. Device according to claim 10, wherein the computing unit comprises a comparator device for comparing the difference between a maximum value and a minimum value of the components of the differential vector (criterion=Δrₘₐₓ−Δrₘᵢₙ) with a differential prescribed value and for outputting a signal if the difference is greater than the differential prescribed value.

13. Device according to claim 10, wherein the computing unit comprises a comparator device for comparing the sum of the absolute values of the components of the differential vector
$$( criterion = {\sum }_{i} Δ \vert {r}_{i} \vert , )$$
with a sum prescribed value and for outputting a signal if the sum is greater than the sum prescribed value.

14. Device according to claim 10, wherein the computing unit comprises a comparator device for comparing the sum of the squares of the components of the differential vector
$$( criterion = {\sum }_{i} Δ {r}_{i}^{2} )$$
with a square sum prescribed value and for outputting a signal if the sum is greater than the square sum prescribed value.

15. Device according to claim 10, wherein the computing unit comprises a comparator device for comparing the number of components of the differential vector which differ significantly from zero with a zero component prescribed value and for outputting a signal if the sum is greater than the zero component prescribed value.

16. Device according to claim 10, wherein the prescribed frequency range lies between about 1 and 5 kHz.
